(19) United States
(12) Patent Application Publication
(10) Pub. No.: US 2003/0204469 A1
(43) Pub. Date: Oct. 30, 2003

(54) Automated reciprocity management system and method of use

(76) Inventor: James Combs, Cumberland, MD (US)

Correspondence Address: SONG K. JUNG, McKenna Long & Aldridge LLP, 1900 K Street, NW, Washington, DC, 20006, US

(21) Appl. No.: 10/318,024

(22) Filed: Dec. 13, 2002

Related U.S. Application Data
(60) Provisional application No. 60/376,195, filed on Apr. 30, 2002.

(51) Int. Cl. G06F 17/60

(52) U.S. Cl. 705/39

(57) ABSTRACT

An automated reciprocity management system for handling the electronic transfer of benefit fund information between participating funds allows users to register participants, modify participant registration profiles, reports, and cessations of funds. The automated reciprocity management system allows expedited transfer of payments to home funds of organization members who travel from one fund jurisdiction to find employment in other fund jurisdictions. Blanket authorizations for reciprocal transfers may be generated and remain effective until modified or cancelled by a participant.

This application claims the benefit of U.S. Provisional Patent Application No. 60/376,195, filed on Apr. 30, 2002, which is hereby incorporated by reference for all purposes as if fully set forth herein.

### BACKGROUND OF THE INVENTION

1. Field of the Invention

The present invention relates to balancing personal and automated systems for collection, tracking and distribution of funds.

2. Discussion of the Related Art

The jurisdiction of unions encompasses many different industries and locations throughout the United States and many different countries around the world. Union members have been known to travel to various locations during their career to continue working at the calling.

Accordingly, a union member may work within jurisdictions of many different local unions and participating in many different benefit funds. During the member's career, however, such mobility may cause coverage for Pension, Health and Welfare benefits to be sacrificed.

With this in mind, reciprocal agreements have been established for Pension funds and Health and Welfare funds in jurisdictions within countries around the world. Reciprocal agreements allow traveling members of an organization to receive credit at their home local union for Pension and Health and Welfare fund contributions earned in another fund's jurisdiction. The intent of these reciprocal agreements has been to bridge the gaps within the inter-jurisdiction coverage of funds and to broaden benefits available to members through reciprocity.

Though reciprocal agreements prevent a loss of benefits to members of local unions, current reciprocity systems require the processing of paper forms by participants to start their transfers every time they travel, by participants to stop active transfers, by funds to report hours, by funds to send money to a participants' selected home fund, etc. The stream of paper forms created an ineffective reciprocity system since it required the processing of forms by hand, mailing processed forms to at least two different fund offices for data entry, followed by the processing and mailing of additional paper reports and checks by the local union funds.

It was this understanding and recognition of the problems with the reciprocity system that formed the impetus for the present invention.

### SUMMARY OF THE INVENTION

Accordingly, the present invention is directed to an automated reciprocal management system that substantially obviates one or more of the problems due to limitations and disadvantages of the related art.

An advantage of the present invention is to provide expedited transfer of Pension and Health and Welfare payments to home funds of organization members who travel from one fund jurisdiction to find employment in other fund jurisdictions. Accordingly, organization members may register with the reciprocal management system of the present invention, entering all the information necessary to have blanket authorization and release(s) on file with the reciprocal management system for a fund transfer. These blanket authorizations become effective once the registered members' (i.e., participant) selected home funds have confirmed their acceptance of home fund designation. These authorizations remain in effect until modified or cancelled by the participant. After the initial registration/blanket authorizations, which must be done in person (with required ID), the participant is issued a userID and password allowing them to either modify their registration profile or to stop transfers. Fund offices are able to exchange information and forms electronically within the reciprocal management system. Additionally, a link to a web-based Automated Clearing House (ACH) is provided to allow for the electronic transfer of money from fund to fund.

According to the principles of the present invention, the reciprocal management system may only be used for the transfer of reciprocal information from fund to fund. No individual personal account information may be accessed on the reciprocal management system. Participants must contact their individual funds for any personal account information.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, as a database system for automated reciprocal management (ARM) using, for example, pension information including: a first tier having at least one client interface; a second tier having stateless architecture that interprets information received from the at least one client interface; and a third tier having a database accessibility by the second tier, responding to a validated query from the at least one client interface.

In another aspect of the present invention, the database employs a specific participant registration and access routine to prevent the unauthorized use of a participant's information, and to securely manage the transmission of the information over the distribution network.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 generally illustrates the components of the reciprocal management system according to the principles of the present invention;

FIG. 2 generally illustrates the production architecture of the database tier within reciprocal management system according to the principles of the present invention;

FIG. 3 generally illustrates the capabilities available within the system administrator role in accordance with the principles of the present invention;

FIG. 4 generally illustrates the capabilities available within the organization/fund administrator roles in accordance with the principles of the present invention;

FIG. 5 generally illustrates the capabilities available within the view only administrator role in accordance with the principles of the present invention;

FIG. 6 generally illustrates the capabilities available within the organization/fund user roles in accordance with the principles of the present invention; and

FIG. 7 generally illustrates the capabilities available within the participant role in accordance with the principles of the present invention.

### DETAILED DESCRIPTION OF THE ILLUSTRATED EMBODIMENTS

Reference will now be made in detail to an embodiment of the present invention, examples of which are illustrated in the accompanying drawings.

The reciprocal management system and method according to the principles of the present invention allows members of an organization to register as a participant and transfer fund information necessary to fulfill reciprocal agreements between different fund jurisdictions. In one aspect of the present invention, fund information that may be transferred relates to various Pension and Healthcare and Welfare funds. In another aspect of the present invention, fund information may be transferred from a home fund to a participating fund, wherein the home and participating funds form a network of pension and health and welfare funds within an organization. In yet another aspect of the present invention, a participating fund may be considered as any benefit fund (e.g., pension, health and welfare, etc.) jointly administered by at least two organizations (e.g., local unions, fund offices, etc.).

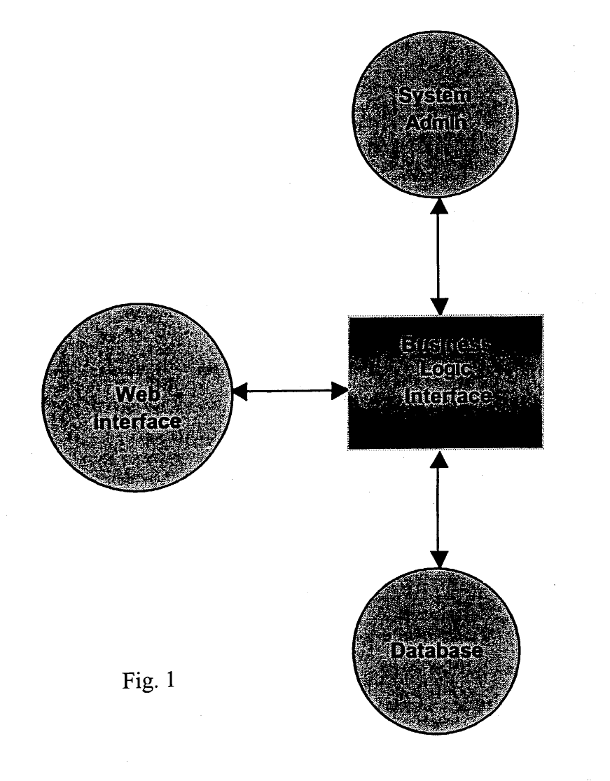

FIG. 1 generally illustrates the components of the reciprocal management system according to the principles of the present invention.

Referring to FIG. 1, the reciprocal management system according to the principles of the present invention may be written primarily using HTML and Java Server Page (JSP) technology and implemented as a web-based application. Accordingly, the reciprocal management system may comprise, for example, client-interface tier, business tier, and database tier components that may be viewed as three independent modules that interact with each other.

Further, the fund information within the reciprocal management system according to the principles of the present invention may be accessed and manipulated by users (e.g., office administrators, business managers, fund administrators, members, etc.) of organizations (e.g., local unions, fund offices, etc.). Each of the users has varying degrees of access (i.e., permissions) to one or more functionalities offered by the reciprocal management system. By logging onto the reciprocal management system, and therefore initiating a session, users may automatically be assigned predetermined permission(s). By assigning users with permissions, roles supported by the reciprocal management system (e.g., administrators, subordinate users, and participants) may thereby invoke.

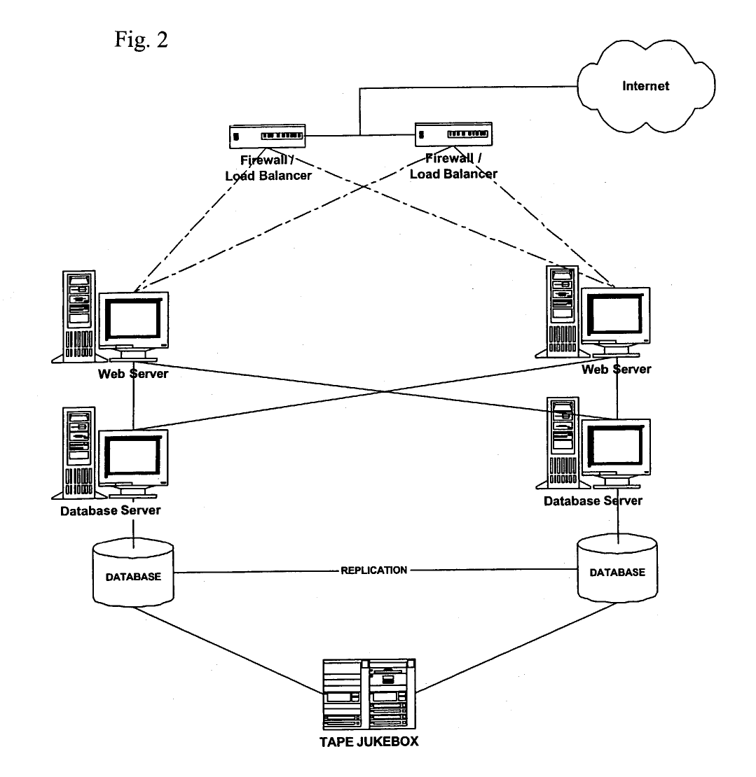

FIG. 2 generally illustrates the production architecture of the database tier within reciprocal management system according to the principles of the present invention.

Referring to FIG. 2, the reciprocal management system may be hosted at a hosting center having high availability, scalable, redundant, and secure systems. For example, the hosting center may include primary and secondary firewalls. The firewall allows specific traffic generated from the World Wide Web (WWW) access to the reciprocal management system. Rules maintained by the firewall provide one example of the mechanism by which to filter all traffic and deny access to unwanted and unauthorized traffic. The firewall only allows access to the HTTP (e.g., port 80), HTTPS (e.g., port 443), and secure shell (e.g., SSH port 22) for application use and administration. The firewall also provides the capability to provide granular security control to allow access to specific domains and IP addresses. Accordingly, the firewall enhances the ability to increase the security of the reciprocal management system.

Servers supporting the reciprocal management system may, for example, run on a private 100 BaseT network connected to a high speed fiber optic (ATM) backbone through the firewall to provide maximum bandwidth for reciprocal fund transfer applications. The web servers provide load-balancing capabilities in order to create a high availability environment. If a first server goes down, a second server has the capability to pick up the load of the first server. The web servers may support up to 5000+ users and include redundant CPUs, error checking memory modules, redundant power supplies, and redundant disk drives with hot-swappable hardware components.

Servers supporting the database tier may include servers with redundant CPUs, multiple CPU configurations, error checking memory modules, redundant power supplies, and redundant disk drives with hot-swappable hardware components, e.g., Redundant Array of Inexpensive Disks (RAID). RDBMS database software may be used to provide the platform to support the reciprocal management system requirements. The database may be scalable to support up to several terabytes (1,000,000,000,000) of data without major impact on the database performance. Implemented with a cluster configuration, the database provides high availability and scalable configuration to support performance needs, minimize downtime and risk to nearly zero. If a first database goes offline, a second database may continue running, completing transactions, with no downtime experienced by the system.

Lastly, a backup tape jukebox library with a storage capacity of approximately 50-100 GB may be provided to facilitate the recovery of any reciprocal fund transfer session in cases of disaster. Copies of the tape may be kept offsite for further protection against disaster. For faster recovery, each server may have a scheduled, automated full backup performed at regular intervals (e.g., once a week). Additionally, incremental backups may be performed between the automated full backups (e.g., each night) onto the tape jukebox on a specified database segment. Accordingly, quick recovery for major problems may be made while the tape jukebox is used for more extensive recovery from more catastrophic failures. Accordingly, the tape jukebox backup may be deployed for fast recovery and minimize system down time due to OS or database corruption/failure.

The reciprocal management system may, for example, use a Secure Hash Algorithm (SHA) and Base64 encoding format to create a password digest or hash of a users' password. Beneficially, SHA is designed to be irreversible, or at least prohibitively expensive to reverse, thus providing strong password encryption. The password may then be stored in the aforementioned database tier.

In one aspect of the present invention, the users may connect to the reciprocal management system, located on one or more servers, using a commonly available web browser via HTTP or HTTPS protocols. Servers supporting the reciprocal management system may activate SSL and establish 128 bit encryption sessions with users to secure the connections so that data transmitted between the users and the system is secure. The 128 bit encryption sessions may originate from certificate issued from a publicly accepted certificate authority (CA) such as VeriSign™. The server certificates may be obtained from a publicly accepted CA. These certificates may support RC4 and Triple DES encryption levels. The users' session may be encrypted when they are connected to provide a secure communication channel for data exchange. All ports on the system web server may be disabled except for the HTTP, HTTPS, SSH, and communications ports to the database server. With SSL in place, the risk of a security breach may be minimized. The only way to capture the userID or password is, for example, for someone to obtain it while the user is entering it on the screen by watching the keys he/she types. Session information is destroyed when the session object is destroyed upon logoff.

Once connected, a user may then be authenticated and an encrypted session between a users' web server and a server supporting the database tier may be initiated. An authenticated user may access the database tier via specific a series of web pages within the client interface tier that are presented according to that users' permissions. A userID and password should be maintained during the session for simple session management.

In one aspect of the present invention, the client-interface tier allows users to interact with the reciprocal management system. Accordingly, the client-interface tier determines how users navigate the reciprocal management system and may be constructed using various Java Server Pages (JSP), JavaScript Cascading Style Sheets (CSS), and HTML pages that help identify boundary classes required by a business logic component of the business tier (as will be discussed in greater detail below) to display output, validate various fields, and get input to and from participants' forms. Accordingly, the client-interface tier may include boundary classes identifiable with respect to functionalities required to capture, transport, and display predetermined information between web pages.

For example, the client-interface tier may include login, registration, search, correspondence, reporting, and administrative modules. Each of these modules includes a specific set of web pages and functionalities that allow users to manipulate fund information and navigate within the reciprocal management system.

The login module facilitates secure predetermined access to the reciprocal management system for participants. In one aspect of the present invention, the predetermined access may be based on a particular users' role within the reciprocal management system, as will be discussed in greater detail below. The login module also manages system security policies (e.g., number of login failures prior to locking of account, password length, roles, administrative capabilities, etc.), and provides an authorization component to the system.

The authorization component enforces row level locking, auditing, and restricted access to objects such as tables and rows. Accordingly, authorization limits access to essential data only to those having authorized permissions to access this data.

As all user interaction with the reciprocal management system begins with the login, data that may be used on this web page to call appropriate entities within the business tier includes userID and password. After a userID and password are provided, the login module within the client interface tier communicates with the business tier to process the actual login by the user into the system.

The registration module facilitates the capture of predetermined registration information from users by administrators, as will be discussed in greater detail below.

The search module provides fund and system administrators the ability to search to participant registration profiles via a set of predetermined criteria (e.g., Last Name, Social Security Number, Participant Number, Address, etc.) to view or update the status of each participant. Functionalities specific to the search module may be provided to administrators but provide search results based on the unique permissions granted to the user. In other words, users with different roles have different search capabilities. For example, a system administrator with a ‘view only’ permission cannot update data associated with a participants' registration profile. System administrators may use the search module to view audit trails of all activities associated with a participants' profile.

The correspondence module is a collection of tools and procedures that may be used to facilitate participant notification and management of notification functionality. With the correspondence module, the reciprocal management system may securely send (e.g., via email) notification to administrators, as will be discussed in greater detail below. Accordingly, the correspondence module allows organizations and users to manage email communications within the reciprocal management system. Within the correspondence module, Java Server Page (JSP) objects may be used to handle all forms of email via Simple Mail Transfer Protocol (STMP). Routing of data to appropriate users may be achieved by interfacing with a server system supporting the reciprocal management system.

In one exemplary aspect of the present invention, the notifications may prompt a fund administrator to access the reciprocal management system to review specific reciprocal requests. In another exemplary aspect of the present invention, the correspondence module may provide a system administrator with the ability to broadcast notifications to a subset or all of the other system administrators.

The reporting module provides the capability for the reciprocal management system to run standard or ad-hoc reports on any event or activity within the reciprocal management system. For example, a system administrator may use the functionality provided by the reporting module to calculate rate conversions of funds or fund types between different countries (e.g., between the United States and Canada), calculate average rates for funds (e.g., health, welfare, pension, etc.), average country rates (e.g., Canadian rate), determine a total number of funds (e.g., pension, health, monitored by the reciprocal management system, locate administrators (e.g., pension, health, etc.); locate and determine a funds' jurisdiction (e.g., state, VP district, etc.); determine the number of funds administered by each fund administrator; determine the effective reciprocal date of each fund transfer; determine whether a fund was reciprocal, etc.

The administrative module provides a system administrator with the ability to activate and deactivate participants and other system administrators within the system. For example, a system administrator may use the functionality provided by the administrative module to reset passwords, view system reports and transfer audit trails, manage the reciprocal management systems' security policies, manage fund rate inputs and changes of various home and participating funds (e.g., Defined Benefits, Defined Contribution and Health and Welfare, etc.) for a single participant, many participants, or multiple classifications of participants, merge funds and maintain links to previous funds for reference purposes, and to maintain online reciprocal agreements between fund administrators of home and participating funds.

In one aspect of the present invention, the business tier allows inputs and outputs of the client interface and database tiers to be coordinated and may be constructed using Java Servlets. In the present aspect, the business tier includes database interface and business logic layers. The business logic layer accepts requests from the client-interface tier, codes the requests in a predetermined protocol accepted by the database tier, and supplies services directly to the client-interface tier. The database interface layer redirects requests from the client-interface tier to the hosts of the database tier through well known routing techniques, obtains answers to the requests, and returns them to the client-interface tier.

In one aspect of the present invention, the business tier may be duplicated on several host systems in order to reduce the overhead of the network and to overcome the limits of servers, computed as the maximum number of connections that can be concurrently managed.

In another aspect of the present invention, access to the business tier from the client-interface tier takes place the same way as a classical Web access. When a service is required by the business tier, a channel (e.g., socket) between systems that implement the tiers (e.g., client-interface and business) is opened for posting the message containing the request and receiving the result. The channel remains open only for the time strictly necessary to satisfy the request, so that the business tier may accomplish requests of multiple users. Consequently, the business tier is not complex as it is a stateless layer. Additionally, the business tier component allows for future changes to be made to the business rules to be made.

In one aspect of the present invention, the database interface layer may contain entity classes that deal directly with actual database operations. Accordingly, these classes may be identified with respect to functionalities required by the database tier to perform any operation. Therefore, the aforementioned functionalities may be encapsulated within the database tier using Modification/Update, Participant Audit Trail Reference, and Participant Audit Trail modules.

The Modifications/Updates module includes tables in the database that may be used to handle specialized logic required during the modification/updating of registration profiles, funds, organizations, etc.

The Participant Audit Trail Reference module may include a reference table containing descriptions relating to codes the participants perform. Accordingly, the functionality provided by the participant audit trail reference module includes read-only lookup style tables.

Lastly, the Participant Audit Trail module includes the database that may be populated with values from the participant audit trail reference, user, TCP/IP address and the current date and time fields so that all user actions may be tracked.

In one aspect of the present invention, the business logic layer contains the entity classes necessary to perform the business logic of the reciprocal management system. These entity classes may be identified by the necessity of the boundary classes to perform client operations in the aforementioned client interface layer.

The business logic layer acts as a bridge between the client interface layer and the database interface layer. The business logic layer includes login, registration, search, confirmation, modification, report, and audit trail modules. These modules provide predetermined functionalities and execute predetermined business rules based on the role invoked upon initiation of a session within the reciprocal management system.

The login module is capable of authenticating a user and of authorizing that user to enter the reciprocal management system. Once a user is authenticated, an audit trail may be initiated or continued from the previous trail if the user was previously logged into the system.

The registration module includes and encapsulates methods necessary to perform the registration process within the reciprocal management system.

The search module includes and encapsulates methods necessary to search a registration profile within the reciprocal management system.

The confirmation module includes and encapsulates methods necessary to confirm and/or deny a request for a reciprocal transfer.

The modification module includes and encapsulates methods necessary to edit and save fields within a registration profile.

The report module includes an entity called when an administrator runs a set of reports (e.g., standard reports) that ensures results generated by the report may be associated with the appropriate role within the system.

The audit trail module includes an entity that allows generations of a user audit trail to be associated with a registration profile and viewed in the administrative section of the client interface layer.

In one aspect of the present invention, the database tier enables functionalities related to registration, blanket reciprocal agreement generation, participant registration profile management, security policies, participating fund rate management, participant activity auditing, etc., within the reciprocal management system. Accordingly, the database tier includes the entire design and architecture of the database involving the insertion and retrieval of data for users to efficiently manage and process reciprocal transfer requests.

The database tier in the reciprocal management system of the present invention captures data elements necessary to register participants, request confirmation from a fund on information associated with the registration profile in order to implement a blanket reciprocal agreement. Additionally, the database may be provided as a relational type database, capture information that generates an audit trail report that tracks a participants' activity within the system, and include tables providing the reciprocal management system with its core functionality.

For example, a table labeled USER_TB may be used to store all participant registration profile information. This information includes the system administrator, organization and fund users with the appropriate participant/administrator type associated to define the roles. USER_TB also maintains the system security policies and tracks modifications to any registration profile within the table. UNION_TB is a table used to store all data associated with an organization such as VP district, state, etc. Accordingly, this table provides the referential data used during the registration process for the reciprocal management system and tracks modifications to any organization information within the table. FUND_TB is a table used to store all data associated with a fund (e.g., participating fund) such as fund type, name, etc. Accordingly, this table provides the referential data used during the registration process of the reciprocal management system and tracks modifications to any fund information within the table. FUND_TYPE_TB is a table used to store the fund codes, fund types, etc., associated with the funds stored in the TUND_TB table. Additionally, this table tracks modifications to any information contained therein. STATE_TB is a table used to store lookup information for all states within an area, e.g., the United States, Canada, etc. UNION_FUND_ASSOC_TB is a table used to store the entire rate and fund information associated with a particular organization such as rate inside, rate outside, etc. Additionally, this table tracks modifications to any information contained therein. USER_UNION_ASSOC_TB is a table used to store the associated reciprocal agreement status for a participant. This table also tracks modifications to any information or change in status contained therein. STATUS_TB is a table used to store all the defined status used within the reciprocal management system that applies to participants, registrations, reciprocal agreements, and registration profiles (e.g., deactivated, pending confirmation, etc.). USER_SESSION_TB is a table used to store participant/administrator logon session information so that access control can be maintained which the participant navigates the reciprocal management system site. USER_TYPE_TB is a table used to store the roles of participants/administrators within the system. CORRESPOND_TB is a table used to manage all the correspondence/email within the system. MISC_INFO TB is a table used to store additional information pertaining to the organization and participating funds (e.g., additional phone numbers, comments, etc.). REMITTANCE_TB is a table used to store records for remittance transactions. REMITT_EMP_LIST_TB is a table used to store the remittance user information records.

In one aspect of the present invention, the administrator role may be characterized as including, for example, system administrator, fund administrator, fund sub-administrator, organization administrator, and organization subadministrator, and view-only administrator roles.

System administrators have permissions allowing their associated users to be capable of maintaining the reciprocal management system. Accordingly, system administrators have every level of access the system offers. Fund administrators and fund sub-administrators (created by the fund administrator) have limited capabilities within the system compared to the system administrators, as will be discussed in greater detail below. Generally managerial capabilities may be filled by organization administrators and organization sub-administrators (created by the organization administrator) within the reciprocal management system, as will be discussed in greater detail below.

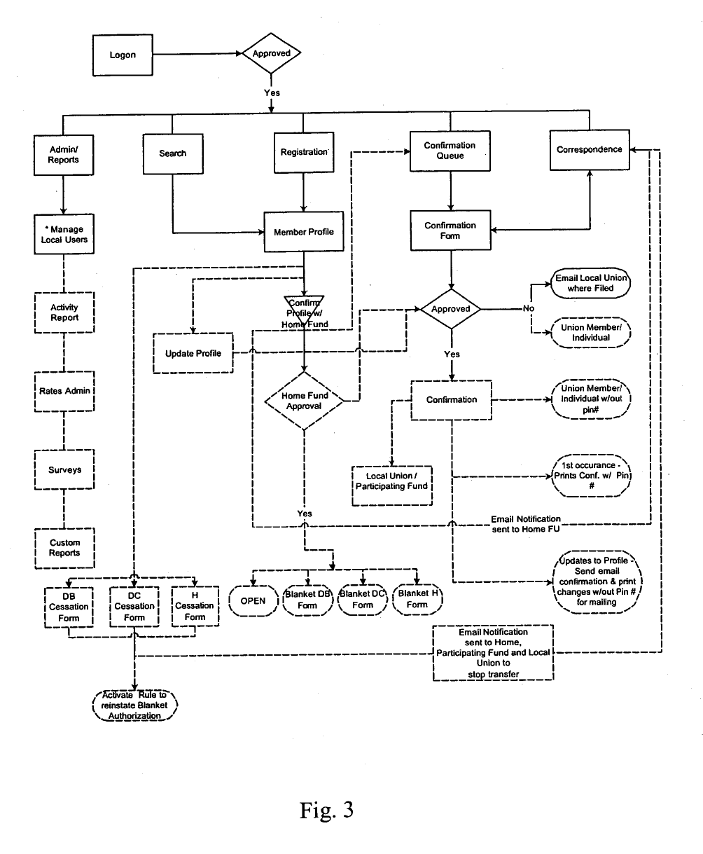

Referring to FIG. 3, the system administrator roles, for example, have the capability to send emails to all or a subset of system administrators within the system, search on all information within the database, run standard reports such as the number of reciprocal transfers processed by an organization, a fund, a group of funds, a geographic area specific to an organization and/or fund (e.g., state, VicePresident district, etc.), or on all transactions. Information related to a total dollar amount of all transfers may be broken down by organizations, funds; areas specific to organizations/funds may also be made available to the system administrator.

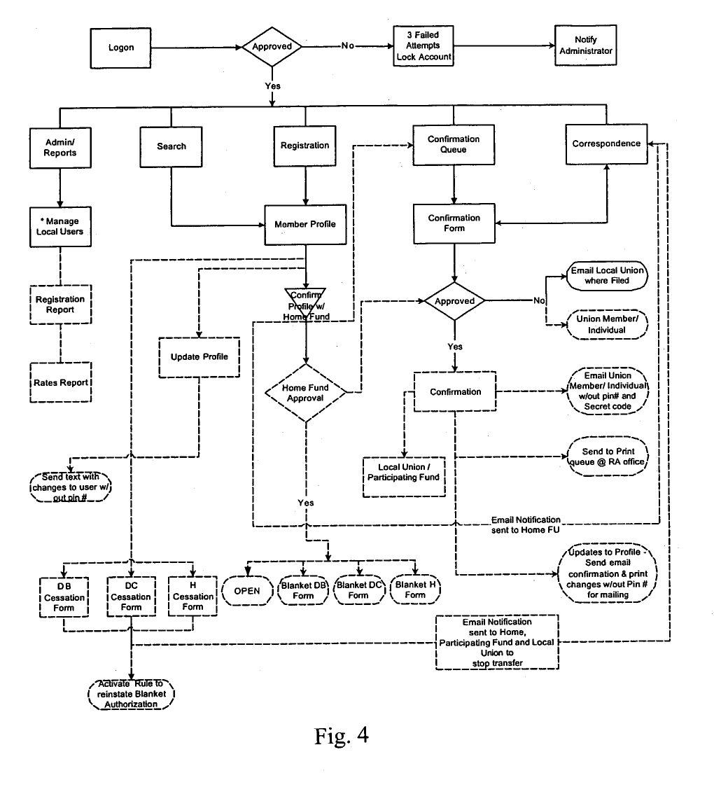

Referring to FIG. 4, the organization/fund administrator roles, for example, have the capability to administer a participant to a particular organization or fund. Accordingly, this role has the ability to create participants and run reports on the activities pertaining to that organization or fund and only to that particular organization or fund.

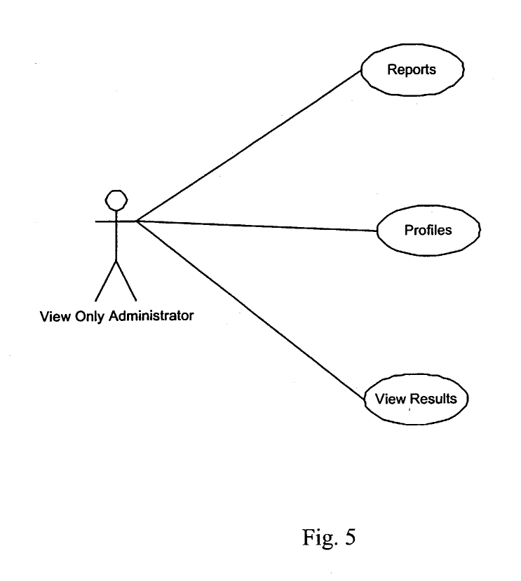

Referring to FIG. 5, the view-only administrator roles, for example, have the capability to search on user registration profiles, run predetermined sets of reports, and view results of searches and reports. This role does not have the capability to update, modify, or change any data within the system.

In one aspect of the present invention, the subordinate user role may, for example, be characterized as including, for example, organization users and fund user roles.

Organization users may be designated by organization administrators to register participants in the reciprocal management system as well as view participant blanket authorizations for reciprocal transfers. Similar to organization users, fund users may be designated by fund administrators to register participants in the system as well as view the blanket authorizations.

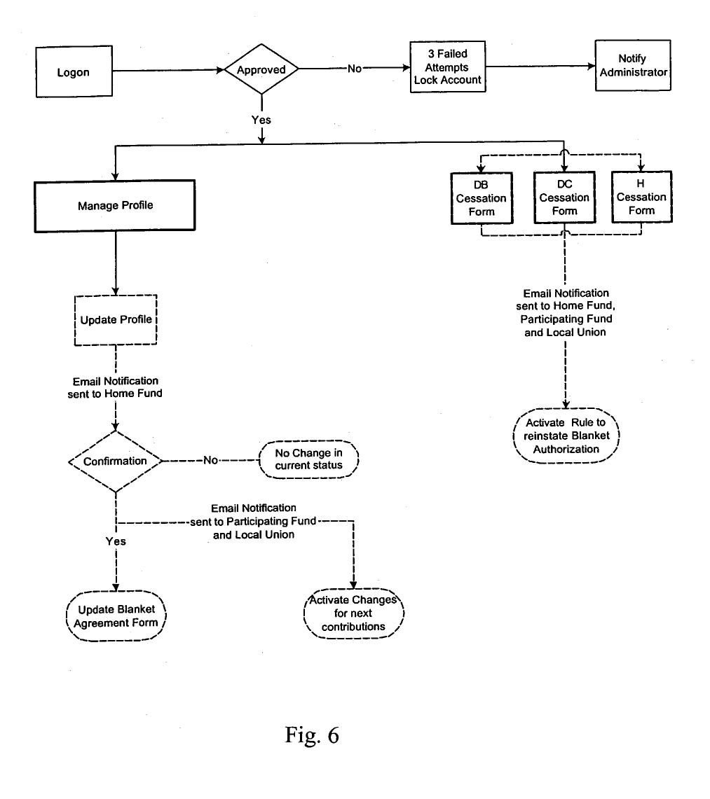

Referring to FIG. 6, the organization/fund user roles have the capability to search for a participants' registration profile and register those participants to the reciprocal management system. Organization/fund user roles also have the capability to view blanket authorization and release(s) if they are in place.

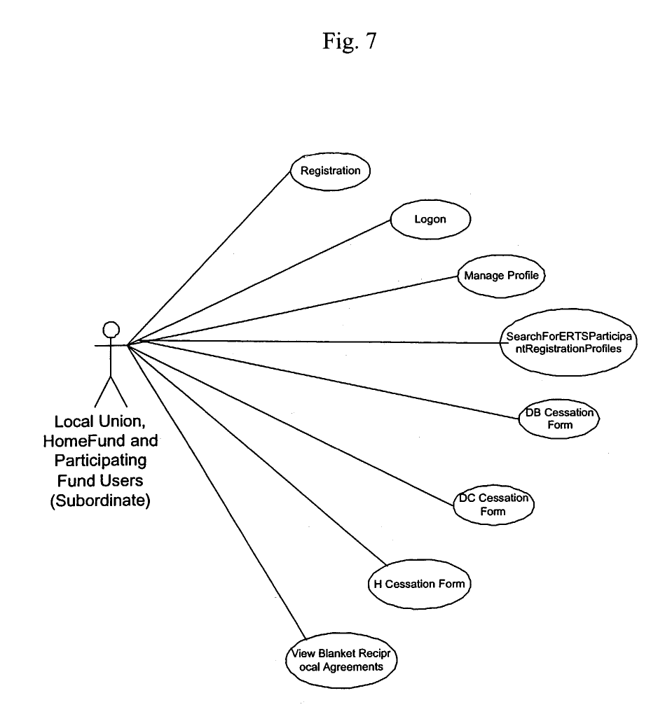

In one aspect of the invention, and while referring to FIG. 7, participants may, for example, manage their own profile once it has been created. This includes modifying and viewing their registration profile and viewing their blanket authorization for a reciprocal transfer. Participants may also file temporary and permanent cessations (e.g., Defined Benefit, Defined Contribution, and Health and Welfare cessations).

In order to enter and manage fund transfer information into and within the reciprocal management system, all users must initially register with the reciprocal management system. In one aspect of the present invention, members of an organization may register as a participant by filling out an on-line participant registration form within an organization office and submitting a photo ID for inspection. Registration with the reciprocal management system at an organization office allows the member to ask questions and to ensure all information is accurately entered into the reciprocal management system. Further, according to another aspect of the present invention, the perspective participant may be registered with an organization prior to registering with the reciprocal management system.

In the present aspect of the invention, the participant registration form may include many fields supported by the business tier. Completion of the participant registration form may require the member to provide, for example, first name, last name, phone number, postal address, government issued social identification (e.g., SSN in the U.S., SIN in Canada, etc.), organization identification number, member identification number, date of birth, email address, and identity of all home funds (e.g., defined benefit and/or defined contribution funds, health and welfare funds, etc.) that exist, within the fields of the online form.

The fields corresponding to the aforementioned home funds are dynamic meaning that the contents of the fields may change based on, for example, a particular organization identification number entered by the member. Accordingly, the fields corresponding to the aforementioned home funds will contain information relevant to a specific organization (or groups of organizations) represented by the particular organization number. Further, a participant registrant must accept all home fund designations. For example, if a participant identifies defined benefit pension, defined contribution pension, and health & welfare funds, the participant must accept all three. If the participant decides not to accept a home fund designation, the specific fund fails to be processed at registration. If the member does not provide any home fund information, the information in that field will default to none.

At the discretion of the system administrator, predetermined users may be registered as organization and/or fund administrators and/or sub-administrators. Accordingly, and in one aspect of the present invention, information required to register an organization or fund administrators may be similar to that required to register participants. Further, organization/fund administrator registrants may also provide an external correspondence address (e.g., an email address) within the registration form. The external correspondence address is required for administrators because the system uses it to notify administrators externally when a participant designates a home fund, any incoming correspondence, and any filing of either a temporary or permanent cessation.

After the participant registration form is completed, a participant registration verification form is provided to the member. The participant registration verification form may be used to confirm the information a member identified during the registration process. Upon reviewing the participant registration verification form and determining that the form identifies the correct information, the participant registration form is processed. In one aspect of the present invention, a participant registration verification page may be printed, signed, and archived for future use. In another aspect of the present invention, a user is not allowed to re-register after they have successfully registered with the reciprocal management system.

The aforementioned registration processes ensure that all users register correctly. Subsequent to successful registration, a registered user is issued a userID) and password will be issued to them. In one aspect of the present invention, the userID and password may be directed to an address (e.g., email, postal address, etc.) identified in the registration form. If either the userID or the password is lost, the participant must contact either an organization or fund office to be re-validated and issued. After the user receives the userID and password, they are capable of accessing to the reciprocal management system anytime and anywhere via an acceptable Internet browser.

In one aspect of the present invention, a user may access the reciprocal management system via the Internet by typing a uniform resource locator (URL) identifying the reciprocal management system. All users may access the reciprocal management system through a common login page. A user may be allowed a predetermined number of unsuccessful attempts (e.g., 5) to login the reciprocal management system. If the userID and/or password are incorrectly entered the predetermined number of times, the users' account is frozen and an organization or fund office is notified. After registration, a participant may access the reciprocal management system by providing, for example, their user name and their identification code.

Authenticated system administrators may register participating funds and organizations within the reciprocal management system. In registering a participating fund or organization, the system administrator specifies at least one of a fund type, fund name, business address, state/province, and fund administrator (or organization business manager). According to one aspect of the present invention, the fund/organization administrator affiliated with that fund/organization may be registered within the reciprocal management system prior to registering the funds.

Contribution/transfer rates of the various funds may be governed and maintained within the reciprocal management system by the system administrator so that they are consistent with rates in various jurisdictions.

Participants within the reciprocal management system may be registered by fund/organization administrators/sub-administrators. Further, fund/organization administrators/sub-administrators may view a participant's blanket authorization for reciprocal transfers, modify their own or a participants' registration profile information, and modify the registration profile of subordinates.

In one aspect of the present invention, an administrator may modify a participants' registration information by performing a search. The search may contain criteria including at least one of a first name, last name, and government issued social identification of the participant. As a result of the search, the administrator will provide a list of participants having registration information matching that of the query for selection. Accordingly, the administrator may modify the registration profiles of fund/organization users, participants, and fund/organization sub-administrators.

The only users that fund/organization administrators may register with the reciprocal management system are fund/organization sub-administrators and subordinate users. Subordinate users have no administrative capabilities, except to register participants, and access reporting capabilities (e.g., reports related to participant blanket authorizations and organization listings) that are generated by the system.

There are, however, some fields containing information that cannot be modified once registration is complete. This information includes, for example, the first name; date of birth, and type of user. However, a new government issued social identification may be added to the registration profile to reflect a change in citizenship, or any other event requiring a user to obtain a new government issued social identification.

Fund/organization administrators may generate, view, and print various reports related to remittance totals, current/historical remittance information, cessation information, blanket authorization information, and fund reciprocal listings (e.g., pension, health, and welfare reciprocal listings).

Hours and monies disbursed from a participating fund to a participant's home fund may be tracked by remittance reports. Fund administrators may report remittances as, for example, new remittances or remittances from a file. In one aspect of the present invention, organization administrators may not generate remittance reports. In one aspect of the present invention, a link to a web-based Automated Clearing House (ACH) may be provided within the reciprocal management system to allow for the electronic transfer of money from fund to fund.

In order to report new remittances, fund administrators may, for example, generate a manual remittance worksheet populated with fields corresponding to the name of a participant, government issued social identification, month reported, hours worked per month, gross wages, hourly rate contribution, total amount transferred per month, etc. Alternatively, fund administrators may access preformatted remittance forms from a predetermined file location and use these reports within the reciprocal management system. An exemplary format of the pre-formatted remittance form may be of a known delimited format containing fields providing information related to the name of the participant, government issued social identification (e.g., SSN, SIN, etc.), month hours worked, total hours worked, gross wages, hourly rate contribution, total transfers, etc.

By specifying a month and year, fund administrators may view current or historical incoming or outgoing monthly remittance information and transfers to and from the fund(s) they administrate. Additionally, fund administrators may view aggregate remittance information within a range of months and/or years.

In one aspect of the present invention, fund administrators may view lists of check/ACH numbers. By selecting a particular check/ACH number, remittance information for that transaction may be provided to the fund administrator. Similarly, organization administrators may also view current, historical, or aggregate remittance information by specifying the necessary dates and/or ranges in addition to the fund(s) associated with the organization. Additionally, by selecting a particular check/ACH number, remittance information for that transaction may be provided to the organization administrator. As system administrators have every capability offered by the system, a system administrator has a filtering capability to display information available to organization and/or fund administrators.

Fund/organization administrators may view and track the cessation history of participants. In one aspect of the present invention, the cessation information may be viewed by providing the name and government issued social identification of the participant.

Fund/organization administrators/sub-administrators and subordinate users may access participants' active blanket authorizations. While participants may also access blanket authorizations, they are limited to access only their own blanket authorizations. To view a blanket authorization of a participant, the name or government issued social identification of the participant may, for example, be provided. A list of blanket authorizations may be provided in response to the aforementioned information. Subsequently, a user or administrator may selectively view any of the listed blanket authorizations.

Fund/organization administrators may generate a report of all the funds (e.g., defined benefit, defined contribution, pension, health, welfare, etc.) in a fund reciprocal listings report. Accordingly, this report lists funds by the organization number they are associated with. Additionally, the fund reciprocal listing report also provides the fund administrators address and any national and international transfer rates.

A search function may be provided to allow fund/organization administrators the ability to view the registration information of any registered user or participating fund/organization. Accordingly, fund/organization administrators may search registration information of a particular registered user by entering, for example, at least the first name, last name, and/or government issued identification of the user. Moreover, fund/organization administrators may search registration information of a particular fund by entering, for example, at least one of a fund name, fund number, or fund type (via pull down menu) to view a list of funds meeting the search criteria. Further, fund/organization administrators may search registration information of a particular organization by entering, for example, at least one of an organization number, jurisdiction, or district (e.g., VP) to view a list of organizations meeting the search criteria. Lastly, the administrators may select, by well-known means, any of the results within the aforementioned lists to view the registration information of the particular user, fund, and/or organization.

Once participants initially register in the reciprocal management system, they cannot access the system until they receive their userID and password from the system administrator. Once participants register, their home fund designation information goes into a confirmation queue for the selected home fund. Fund administrators are then notified, via external email, to check their confirmation queue to verify a participants' eligibility.

If participants need to be approved for reciprocity, they will appear in the confirmation queue. Once the information is verified, the fund administrator may set the eligibility of the participant and posts the participants' eligibility on a verification list showing which participants are approved for transfer and which are rejected.

The correspondence function allows fund/organization administrators to communicate back and forth with other fund/organization/system administrators. Fund administrators/organization business managers may initiate correspondence with other fund/organization/system administrators. Any of the aforementioned administrators may also select attachments to be sent using the correspondence module.

The correspondence functionality allows fund/organization administrators to send messages to individual funds, organizations, or system administrators. To create a new correspondence, a user may select the recipients of the correspondence via a series of pull down windows. Fund/organization administrators may send messages to an individual organization, participating fund, or system administrator. When selecting organizations or funds, the reciprocal management system will use the organizations and fund associations to filter selections. Administrators may select the organization or funds to identify whom the correspondence will be sent. Once the selection is made, the organization or fund fields within the correspondence may be populated automatically.

Subsequently, the subject of the correspondence may be provided. Correspondence 'subjects' are then displayed within the correspondence queues of the other administrators. Next, an appropriate message is entered. Attachments may be added to the messages.

Once the correspondence has been generated, the correspondence may be sent through the network to the intended recipient(s). A confirmation of the sent correspondence may be generated automatically.

Fund/organization administrators may view and track messages sent by organizations or funds. Once selected, organization members or fund names may be listed. Selecting a number or name displays the correspondence history related to the selected organization member or fund name.

The system administrator is responsible for conducting surveys through the system. The system administrator has the ability to send fund/organization administrators questions. To access and respond to these questions, the recipients may access the 'surveys' functionality, by well-known means, and respond to the questions.

Participants of the reciprocal management system are capable of viewing their blanket authorization, viewing their registration profile, modifying their registration, filing temporary cessations, filing permanent cessations.

The reciprocal management system allows participants the ability to process their own fund cessation forms (e.g., Define Benefit, Defined Contribution, Health, etc.). Accordingly, after designating a participating organization and participating fund name, the participant may generate a fund cessation acceptance form. Upon completion of the fund cessation acceptance form, a transaction is completed. Each fund cessation acceptance form may include similar fields as included in the participant registration form and further include a fields containing a participating organization identification number and participating fund names. The fields corresponding to the aforementioned participating funds are dynamic and dependent on the participating organization identification number provided. Subsequent to completing a fund cessation acceptance form, the transaction is processed and home and participating organizations/funds are notified.

A blanket authorization results from the registration only after the home fund identified in the participant registration form accepts the participant for reciprocity. The blanket authorization remains in effect until the participant submits a permanent cessation form or modifies their registration. A temporary cessation form will not modify registration or render a blanket authorization inactive.

After a participant successfully logs into the system, a statement on a blanket authorization acceptance form appears and forces the user to accept the policies of the reciprocal management system. If the participant does not accept the statement, the user is logged off of the system. If the participant does accept the statement, the participant is admitted into the system, a record containing, for example, the userID, date, and time for each acceptance, is generated within the database, and the participant assumes the role defined by the permissions associated with their userID and password.

In one aspect of the present invention, blanket authorizations for reciprocal transfers are not put into place until the specific fund identified by the participant accepts the participant for reciprocity. The participant may be notified via email (if an email address was identified in the registration process) or via mail, phone, facsimile, verbal instructions or other acceptable means, from a local organization or fund office, if they were accepted by the fund.

A participant may view the blanket authorizations that have been put in place after the identified funds have been approved them for reciprocity. There may be provided separate blanket authorizations for each defined benefit, defined contribution, and health and welfare funds. For example, if a participant is not approved or did not indicate a direct contribution home fund designation, then there will not be a link to a direct contribution authorization.

The participant may also access, for example, pension reciprocal agreements, health and welfare agreements, explanation of the typical operation of the pension reciprocal agreement, explanation of the typical operation of the health and welfare reciprocal agreement, etc., in “.pdf”, or any other suitable format.

A participant may modify their registration profile. Prior to modifying the information, the participant may be prompted to accept a “modify participant registration” statement. If the participant does not accept the terms within the statement, the reciprocal management system will not allow the participant to modify the registration information. Once the participant accepts the terms, they are able to modify predetermined registration information. A participant may modify the home fund designation. Any modification of home fund designation is subject to approval by the fund office.

A participant may view the information entered when they either registered with reciprocal management system or modified their registration profile.

Using the reciprocal management system according to the principles of the present invention, a participant may file a temporary cessation. Accordingly, after accepting a cessation form agreement statement, a participant may select a predetermined blanket authorization (Defined Benefit, Defined Contribution, Health and Welfare, etc.) they wish to file. Filing a temporary cessation does not modify any registration information and does not delete a blanket authorization. A temporary cessation only temporarily stops the transfer of funds.

After identifying the participating organization number and participating fund name, the participant must then accept the terms of the agreement prior to finishing the transaction. If the participant does not accept the terms, the transaction will terminate. The participant also has the ability to print the information entered into the temporary cessation form.

Using the reciprocal management system according to the principles of the present invention, a participant may file a permanent cessation. Accordingly, after accepting a cessation form agreement statement, a participant may select a predetermined blanket authorization (Defined Benefit, Defined Contribution, Health and Welfare, etc.) they wish to file. Once processed, the permanent cessation transaction deletes the blanket authorization that was initially chosen by the participant. If the participant does not have a participating organization upon filing the permanent cessation, the participant must select, for example, a “not selected” option within the organization field.

After identifying the participating organization number and participating fund name, the participant must then accept the terms of the agreement prior to finishing the transaction. If the participant does not accept the terms, the transaction will terminate. The participant also has the ability to print the information entered into the temporary cessation form.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A database system for automated reciprocal management (ARM) using pension information including:
a first tier having at least one client interface;
a second tier having stateless architecture that interprets information received from the at least one client interface; and
a third tier having a database accessible by the second tier, responding to a validated query from the at least one client interface.

2. The database system of claim 1, wherein the client interface further includes participant registration.

3. The database system of claim 2, further includes a temporary identification for session-based transactions.

4. The database system of claim 1, wherein the second tier further includes transfer of participant account information between reciprocal sources.

5. The database system of claim 4, further includes transmission by at least one of the following: telecommunication, telex, or TCP/IP.

6. The database system of claim 1, wherein the third tier further includes a plurality networked scalable servers.

7. The database system of claim 6, further including a separate backup system and method.

8. The database system of claim 7, further including scheduled recovery protocol, with distinct geographically separate locations.

9. A database system for automated reciprocal management (ARM) using pension information including:
a participant identification protocol;
a reciprocal access to a plurality of managed pension information sources; and
a reciprocal accounting of pension participating services to the participant.

10. The database system of claim 9, wherein the participant protocol includes an initial intake meeting for all necessary information for blanket authorization at a brick and mortar location.

11. The database system of claim 10, wherein all subsequent participant protocol includes a web-based access using TCP/IP, including at least one of HTTP and HTTPS.

12. The database system of claim 11, wherein all subsequent participant protocol includes at least one of the following: login, registration, search, correspondence, reporting and administration.

13. The database system of claim 9, wherein the reciprocal access further includes an optional web-based automated clearing house (ACH) manager for access to managed pension information sources, including at least one of health information or welfare information sources.

14. The database system of claim 13, wherein the reciprocal access further includes a business logic layer that accepts the requests from the participant, codes the requests in a predetermined protocol for processing, and returns the information services directly to the participant.

15. The database system of claim 9, wherein the reciprocal accountability further includes a managed insertion and retrieval network of information data.

16. The database system of claim 14, further includes at least one of a relational type database or an object type database.

17. A method of operation for an automated reciprocal management (ARM) using pension information including:
generating a participant identification protocol;
coordinating a reciprocal access to a plurality of managed pension information sources; and
delivering a reciprocal accounting of pension participating services to the participant.

18. The method of claim 17, wherein the participant protocol includes an initial intake meeting for all necessary information for blanket authorization at a brick and mortar location.

19. The method of claim 18, wherein all subsequent participant protocol includes a web-based access using TCP/IP, including at least one of HTTP and HTTPS.

20. The method of claim 19, wherein all subsequent participant protocol includes at least one of the following: login, registration, search, correspondence, reporting and administration.

21. The method of claim 17, wherein the reciprocal access further includes an optional web-based automated clearing house (ACH) manager for access to managed pension information sources, including at least one of health information or welfare information sources.

22. The method of claim 21, wherein the reciprocal access further includes a business logic layer that accepts the requests from the participant, codes the requests in a predetermined protocol for processing, and returns the information services directly to the participant.
